(19) United States
(12) Patent Application Publication
(10) Pub. No.: US 2012/0249511 A1
(43) Pub. Date: Oct. 4, 2012

(54) SOURCE DRIVER FOR AN LCD PANEL

(75) Inventors: Cheng-Lin SHIU, Miaoli County (TW); Wen-Shian Shie, Miaoli County (TW); Hung-An Huang, Miaoli County (TW)

(73) Assignee: Fitipower Integrated Technology Inc., Miaoli County (TW)

(21) Appl. No.: 13/435,254

(22) Filed: Mar. 30, 2012

(30) Foreign Application Priority Data
Apr. 1, 2011 (TW) 100111667

(51) Int. Cl. G09G 3/36; G09G 5/00

(52) U.S. Cl. 345/211; 345/87

(57) ABSTRACT

A source driver for an LCD panel includes two gm stages and two output buffers. In a normal operation mode, the first gm stage and the first output buffer establish a unity gain buffer to amplify a positive polarity analog voltage to be a positive polarity output voltage, and the second gm stage and the second output buffer establish a unity gain buffer to amplify a negative polarity analog voltage to be a negative polarity output voltage. In a polarity inversion mode, the second gm stage and the first output buffer establish a unity gain buffer to amplify a positive polarity analog voltage to be a positive polarity output voltage, and the first gm stage and the second output buffer establish a unity gain buffer to amplify a negative polarity analog voltage to be a negative polarity output voltage.

### FIELD OF THE INVENTION

The present invention is related generally to a source driver for a liquid crystal display (LCD) panel and, more particularly, to an amplifier circuit in a source driver for an LCD panel.

### BACKGROUND OF THE INVENTION

The display principle of an LCD is using voltages to control the rotation angles of liquid crystalline molecules to change the transparence thereof to thereby produce various levels of brightness. FIG. 1 is an equivalent circuit of a pixel of an LCD panel, in which a MOSFET M1 has its gate and drain connected to a gate driver 16 and a source driver 20 through a scan line 10 and a data line 12 respectively, a capacitor Cs is connected between the source of the MOSFET M1 and a common node Vcom, the gate driver 16 controls the MOSFET M1 to turn on/off, and the source driver 20 determines the voltage Vs to be applied to the capacitor Cs. When the MOSFET M1 is on, the differential voltage Vs−Vcom between the opposite electrodes of the capacitor Cs determines the rotation angle of the liquid crystalline molecules of the pixel and thereby determine the transparence of the pixel. Therefore, the brightness of the pixel can be controlled by changing the differential voltage Vs−Vcom. The differential voltage Vs−Vcom may be positive or negative. When the voltage Vs is higher than the common voltage Vcom, it is regarded as a positive polarity, and when the voltage Vs is lower than the common voltage Vcom, it is regarded as a negative polarity.

Different voltage polarities result in different rotation directions of the liquid crystalline molecules. However, as long as the absolute values of the differential voltages Vs−Vcom are equal, a same transparence will be achieved. For example, the differential voltages of +1V and of −1V result in a same transparence. Nevertheless, when being applied with an unchanged voltage for a sustained period of time, the liquid crystalline molecules will be polarized and become no longer capable of rotating in response to the voltage variation. Thus, when a certain level of brightness is required to be maintained for a sustained period of time, repeated alternation of positive and negative polarity voltages can help preventing the liquid crystalline molecules from being polarized. To achieve this purpose, the source driver 20 operates in a normal operation mode or in a polarity inversion mode.

The source driver 20 is constructed with a plurality of channels whose outputs are connected to data lines, for example, the data lines 12 and 14 shown in FIG. 1. FIG. 2 is a simplified diagram of two channels in the source driver 20, in which a latch 22, a level shifter 24, a positive polarity digital-to-analog converter (PDAC) 26, an gm stage 28 and an output buffer 30 establish a positive polarity channel for providing a positive polarity output voltage VsP to the data line 12, and a latch 32, a level shifter 34, a negative polarity digital-to-analog converter (NDAC) 36, a gm stage 38 and an output buffer 40 establish a negative polarity channel for providing a negative polarity output voltage VsN to the data line 14. In the normal operation mode, the latches 22 and 32 receive and store digital grayscale signals Dgray1 and Dgray2 respectively, the level shifters 24 and 34 obtain the digital grayscale signals Dgray1 and Dgray2 from the latches 22 and 32 respectively, and convert the digital grayscale signals Dgray1 and Dgray2 into digital grayscale signals Dgray3 and Dgray4 of higher levels, respectively, the PDAC 26 converts the digital grayscale signal Dgray3 into a positive polarity analog voltage VIP, the NDAC 36 converts the digital grayscale signal Dgray4 into a negative polarity analog voltage VIN, the gm stage 28 and the output buffer 30 establish a unity gain buffer 31 to amplify the positive polarity analog voltage VIP to be the positive polarity output voltage VsP, and the gm stage 38 and the output buffer 40 establish a unity gain buffer 41 to amplify the negative polarity analog voltage VIN to be the negative polarity output voltage VsN. In the unity gain buffer 31, the gm stage 28 having power input ports VDDA and GNDA amplifies the difference between the positive polarity analog voltage VIP and the positive polarity output voltage VsP to be a signal Sd1, and the output buffer 30 having power input ports VDDA and GNDA generates the positive polarity output voltage VsP for the data line 12 according to the signal Sd1. In the unity gain buffer 41, the gm stage 38 having power input ports VDDA and GNDA amplifies the difference between the negative polarity analog voltage VIN and the negative polarity output voltage VsN to be a signal Sd2, and the output buffer 40 having power input ports VDDA and GNDA generates the negative polarity output voltage VsN for the data line 14 according to the signal Sd2.

When the LCD panel displays a static picture for a certain period of time, for preventing the liquid crystalline molecules from being polarized, the source driver 20 enters a polarity inversion mode. As shown in FIG. 3, the digital grayscale signal Dgray1 stored in the latch 22 is now sent to the level shifter 34 to generate a digital grayscale signal Dgray3, the digital grayscale signal Dgray2 stored in the latch 32 is now sent to the level shifter 24 to generate a digital grayscale signal Dgray4, the PDAC 26 converts the digital grayscale signal Dgray4 into a positive polarity analog voltage VIP, the NDAC 36 converts the digital grayscale signal Dgray3 into a negative polarity analog voltage VIN, the unity gain buffer 31 generates a negative polarity output voltage VsN for the data line 12 according to the negative polarity analog voltage VIN, and the unity gain buffer 41 generates a positive polarity output voltage VsP for the data line 14 according to the positive polarity analog voltage VIP.

Referring to FIGS. 1 and 2, the level of the common voltage Vcom is between the levels of the high supply voltage VDDA and the low supply voltage GNDA of the source driver 20, the positive polarity analog voltage VIP and the positive polarity output voltage VsP are within the range between VDDA and Vcom, and the negative polarity analog voltage VIN and the negative polarity output voltage VsN are within the range between Vcom and GNDA. In FIG. 2, the output buffer 30 generates the positive polarity voltage VsP within the range between VDDA and Vcom, while in FIG. 3, the output buffer 30 generates the negative polarity voltage VsN within the range between Vcom and GNDA, and therefore the output buffer 30 has to generate a voltage within the range between VDDA and GNDA, so the MOSFET therein has to be capable of withstanding a differential voltage as large as VDDA−GNDA. Likewise, the MOSFET inside the output buffer 40 has to be capable of withstanding a differential voltage as large as VDDA−GNDA. Thus, the output buffers 30 and 40 require larger chip areas and thereby require higher manufacturing costs.

### SUMMARY OF THE INVENTION

An objective of the present invention is to provide a source driver for an LCD panel.

Another objective of the present invention is to provide a source driver with lower costs and smaller chip area.

According to the present invention, a source driver operates in a normal operation mode or a polarity inversion mode to provide a first output voltage in a first voltage range and a second output voltage in a second voltage range to two data lines of an LCD panel. The first output voltage and the second output voltage are different from each other. A first latch receives and stores a first digital grayscale signal, a second latch receives and stores a second digital grayscale signal, a first level shifter converts the first digital grayscale signal into a third digital grayscale signal in the normal operation mode, and converts the second digital grayscale signal into a fourth digital grayscale signal in the polarity inversion mode, a second level shifter converts the second digital grayscale signal into the fourth digital grayscale signal in the normal operation mode, and converts the first digital grayscale signal into the third digital grayscale signal in the polarity inversion mode, a positive polarity digital-to-analog converter converts the output of the first level shifter into a positive polarity analog voltage, and a negative polarity digital-to-analog converter converts the output of the second level shifter into a negative polarity analog voltage. In the normal operation mode, a first gm stage and a first output buffer establish a unity gain buffer to amplify the positive polarity analog voltage to be a positive polarity output voltage, and a second gm stage and a second output buffer establish a unity gain buffer to amplify the negative polarity analog voltage to be a negative polarity output voltage. In the polarity inversion mode, the second gm stage and the first output buffer establish a unity gain buffer to amplify the positive polarity voltage to be a positive polarity output voltage, and the first gm stage and the second output buffer establish a unity gain buffer to amplify the negative polarity voltage to be a negative polarity output voltage.

### BRIEF DESCRIPTION OF THE DRAWINGS

These and other objectives, features and advantages of the present invention will become apparent to those skilled in the art upon consideration of the following description of the preferred embodiments of the present invention taken in conjunction with the accompanying drawings, in which:

FIG. 1 is an equivalent circuit of a pixel of an LCD panel;

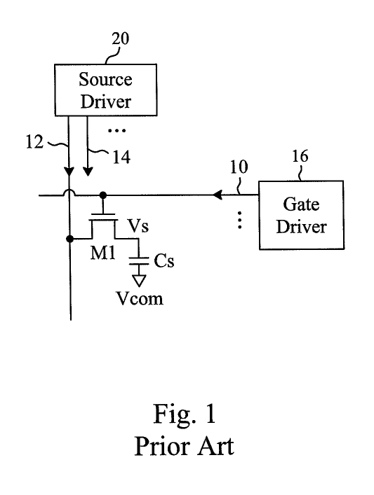

FIG. 2 is a simplified diagram of two channels in a source driver in a normal operation mode;

FIG. 3 is the conventional source driver of FIG. 2 in a polarity inversion mode;

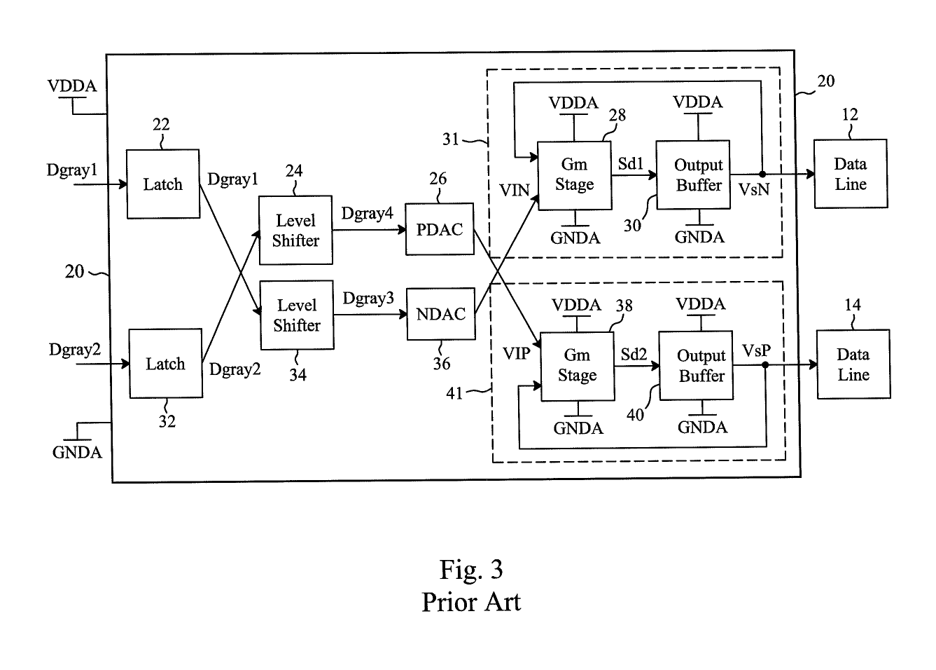

FIG. 4 is a simplified diagram of two channels in a source driver in a polarity inversion mode according to the present invention;

FIG. 5 is a circuit diagram of a cross switch for the unity gain buffers shown in FIG. 4;

FIG. 6 is a circuit diagram of an embodiment for the gm stage and the output buffer shown in FIG. 5; and

FIG. 7 is a circuit diagram of an embodiment for the gm stage and the output shown in FIG. 5.

### DETAILED DESCRIPTION OF THE INVENTION

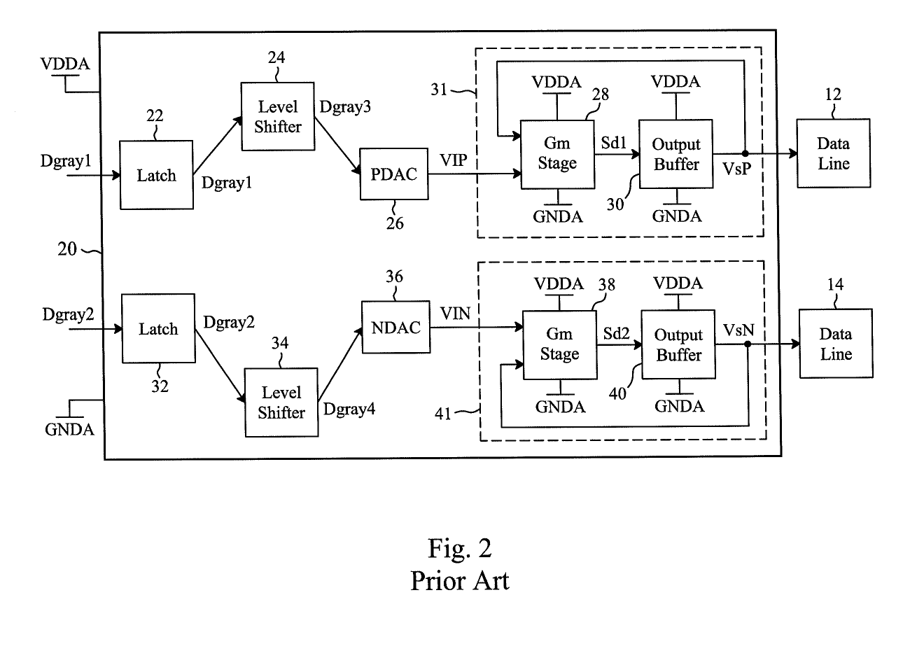

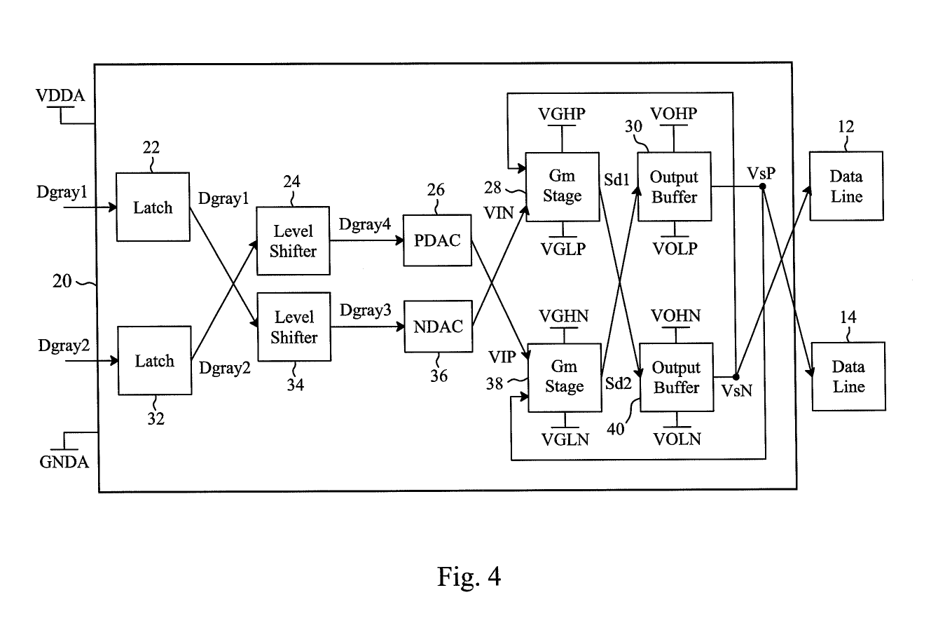

FIG. 4 is a simplified diagram of two channels in a source driver in a polarity inversion mode according to the present invention. This source driver 20 will have an equivalent circuit to that shown in FIG. 2 when it is in a normal operation mode; however, it will have the circuit as shown in FIG. 4 when entering its polarity inversion mode, in which the digital grayscale signal Dgray1 stored in the latch 22 is sent to the level shifter 34 to generate a digital grayscale signal Dgray3, the digital grayscale signal Dgray2 stored in the latch 32 is sent to the level shifter 24 to generate a digital grayscale signal Dgray4, the positive polarity analog voltage VIP converted from the digital grayscale signal Dgray4 by the PDAC 26 is provided to the gm stage 38, the negative polarity analog voltage VIN converted from the digital grayscale signal Dgray3 by the NDAC 36 is provided to the gm stage 28, the gm stage 28 amplifies the difference between the negative polarity analog voltage VIN and the negative polarity output voltage VsN to generate a signal Sd1, the output buffer 40 generates the negative polarity output voltage VsN for the data line 12 according to the signal Sd1, the gm stage 38 amplifies the difference between the positive polarity analog voltage VIP and the positive polarity output voltage VsP to generate a signal Sd2, and the output buffer 30 generates the positive output voltage VsP for the data line 14 according to the signal Sd2. In this embodiment, in the polarity inversion mode, the gm stage 28 and the output buffer 40 establish a unity gain buffer for generating the negative polarity output voltage VsN, and the gm stage 38 and the output buffer 30 establish a unity gain buffer for generating the positive polarity output voltage VsP. In FIG. 4, the power input port VGHP of the gm stage 28 and the power input port VGHN of the gm stage 38 are connected to the high supply voltage input port VDDA of the source driver 20, and the power input port VGLP of the gm stag 28 and the power input port of the gm stag VGLN 38 are connected to the low supply voltage input port GNDA of the source driver 20. However, these two sets of power input ports may be connected to voltage sources of different levels, respectively, as long as the provided voltages thereacross are greater than the output voltage ranges of the PDAC 26 and the NDAC 36.

Referring to FIGS. 2 and 4, either in the normal operation mode or in the polarity inversion mode, the output buffer 30 only outputs the positive polarity output voltage VsP within the voltage range between VDDA and Vcom, and the output buffer 40 only outputs the negative polarity output voltage VsN within the voltage range between Vcom and GNDA. Thus, the internal circuits of the output buffers 30 and 40 may use MOSFETs of lower breakdown voltages to reduce the chip areas of the output buffers 30 and 40. In addition, since the output buffer 30 only outputs the positive polarity output voltage VsP, the power input port VOLP thereof may be connected to voltage sources of different levels, as long as its voltage is lower than the minimum output voltage of the PDAC 26. Likewise, since the output buffer 40 only outputs the negative polarity output voltage VsN, the power input port VOHN thereof may be connected to voltage sources of different levels, as long as its voltage is higher than the maximum output voltage of the NDAC 36.

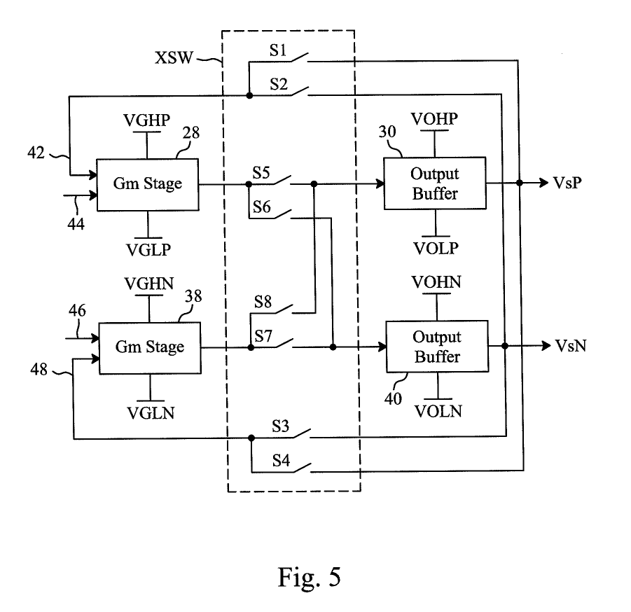

FIG. 5 is a circuit diagram of a cross switch XSW for the unity gain buffers shown in FIG. 4, in which switches S1 and S2 are connected between the feedback input port 42 of the gm stage 28 and the output port VsP of the output buffer 30 and the output port VsN of the output buffer 40 respectively, switches S3 and S4 are connected between the feedback input port 48 of the gm stage 38 and the output port VsN of the output buffer 40 and the output port VsP of the output buffer 30 respectively, switches S5 and S6 are connected between the output port of the gm stage 28 and the input ports of the output buffers 30 and 40 respectively, and switches S7 and S8 are connected between the output port of the gm stage 38 and the input ports of the output buffers 40 and 30 respectively. In the normal operation mode, the input ports 44 and 46 of the gm stages 28 and 38 receive the positive polarity analog voltage VIP and the negative polarity analog voltage VIN respectively, the switches S1, S3, S5 and S7 are on, and the switches S2, S4, S6 and S8 are off. In the polarity inversion mode, the input ports 44 and 46 of the gm stages 28 and 38 receive the negative polarity analog voltage VIN and the positive polarity analog voltage VIP respectively, the switches S1, S3, S5 and S7 are off, and the switches S2, S4, S6 and S8 are on.

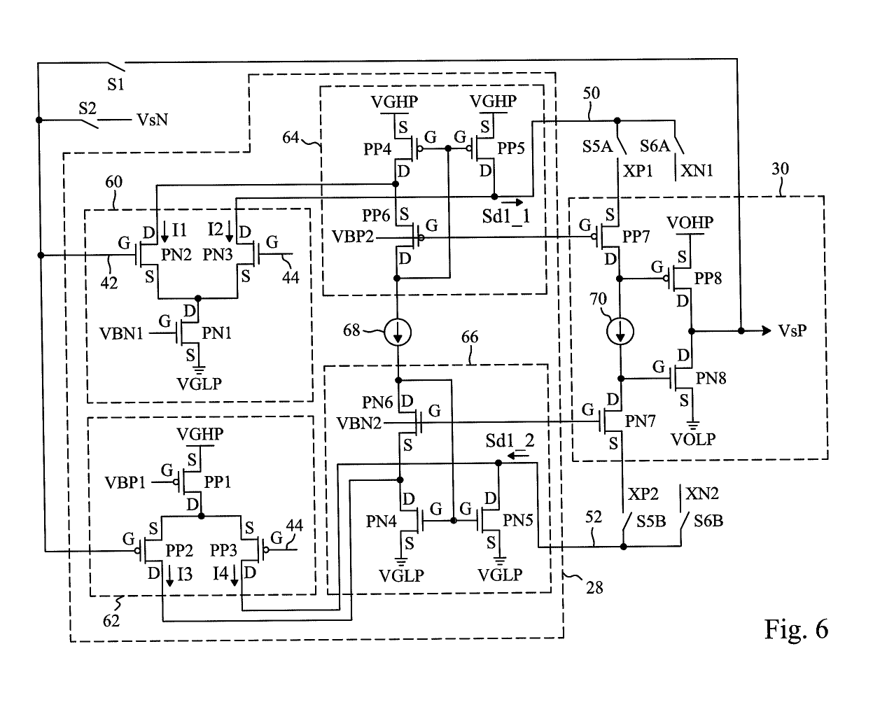

FIG. 6 is a circuit diagram of an embodiment for the gm stage 28 and the output buffer 30 shown in FIG. 5. In the normal operation mode, output ports 50 and 52 of the gm stage 28 are connected to input ports XP1 and XP2 of the output buffer 30 through switches S5A and S5B, respectively. In the polarity inversion mode, the output ports 50 and 52 of the gm stage 28 are connected to input ports XN1 and XN2 of the output buffer 40 through switches S6A and S6B, respectively. The gm stage 28 includes input differential pairs 60 and 62, current mirrors 64 and 66, and a bias current source 68 connected between the reference branches of the current mirrors 64 and 66. The input differential pair 60 includes NMOSFETs PN1, PN2 and PN3, the source of the NMOSFET PN1 is connected to the power input port VGLP, the gate of the NMOSFET PN1 receives a bias voltage VBN1, the gate of the NMOSFET PN2 is one of two input ports of the input differential pair 60 and is connected to the input port 42 of the gm stage 28, the source of the NMOSFET PN2 is connected to the drain of the NMOSFET PN1, the drain of the NMOSFET PN2 is one of two output ports of the input differential pair 60 and is connected to the current mirror 64, the gate of the NMOSFET PN3 is the other input port of the input differential pair 60 and is connected to the input port 44 of the gm stage 28, the source of the NMOSFET PN3 is connected to the drain of the NMOSFET PN1, and the drain of the NMOSFET PN3 is the other output port of the input differential pair 60 and is connected to the current mirror 64. The input differential pair 62 includes PMOSFETs PP1, PP2 and PP3, the source of the PMOSFET PP1 is connected to the power input port VGHP, the gate of the PMOSFET PP1 receives a bias voltage VBP1, the drain of the PMOSFET PP1 is connected to the sources of the PMOSFETs PP2 and PP3, the gate of the PMOSFET PP2 is one of two input ports of the input differential pair 62 and is connected to the input port 42 of the gm stage 28, the drain of the PMOSFET PP2 is one of two output ports of the input differential pair 62 and is connected to the current mirror 66, the gate of the PMOSFET PP3 is the other input port of the input differential pair 62 and is connected to the input port 44 of the gm stage 28, and the drain of the PMOSFET PP3 is the other output port of the input differential pair 62 and is connected to the current mirror 66. The current mirror 64 includes PMOSFETs PP4, PP5 and PP6, the sources of the PMOSFETs PP4 and PP5 are connected to the power input port VGHP, the gate of the PMOSFET PP4 is connected to the gate of the PMOSFET PP5 and the drain of the PMOSFET PP6, the drain of the PMOSFET PP4 is connected to the drain of the NMOSFET PN2 and the source of the PMOSFET PP6, the drain of the PMOSFET PP5 is connected to the drain of the NMOSFET PN3 and the output port 50 of the gm stage 28, the gate of the PMOSFET PP6 receives a bias voltage VBP2, and the PMOSFETs PP4 and PP5 are the reference branch and the mirror branch of the current mirror 64, respectively. The current mirror 66 includes NMOSFETs PN4, PN5 and PN6, the sources of the NMOSFETs PN4 and PN5 are connected to the power input port VGLP, the gate of the NMOSFET PN4 is connected to the gate of the NMOSFET PN5 and the drain of the NMOSFET PN6, the drain of the NMOSFET PN4 is connected to the drain of the PMOSFET PP2 and the source of the NMOSFET PN6, the drain of the NMOSFET PN5 is connected to the drain of the PMOSFET PP3 and the output port 52 of the gm stage 28, the gate of the NMOSFET PN6 receives a bias voltage VBN2, and the NMOSFETs PN4 and PN5 are the reference branch and the mirror branch of the current mirror 66, respectively. The input differential pairs 60 and 62 determines currents I1, I2, I3 and I4 according to the differential voltage between the input ports 42 and 44 of the gm stage 28, and thereby determine the signals Sd1_1 and Sd1_2 at the output ports 50 and 52 of the gm stage 28.

In the embodiment of FIG. 6, the output buffer 30 has PMOSFETs PP7 and PP8, NMOSFETs PN7 and PN8, and a bias current source 70, the source of the PMOSFET PP7 is connected to the input port XP1 of the output buffer 30, the gate of the PMOSFET PP7 receives the bias voltage VBP2, the drain of the PMOSFET PP7 is connected to the bias current source 70 and the gate of the PMOSFET PP8, the source of the NMOSFET PN7 is connected to the input port XP2 of the output buffer 30, the gate of the NMOSFET PN7 receives the bias voltage VBN2, the drain of the NMOSFET PN7 is connected to the bias current source 70 and the gate of the NMOSFET PN8, the source of the PMOSFET PP8 is connected to the power input port VOHP, the drain of the PMOSFET PP8 is connected to the output port VsP of the output buffer 30, the source of the NMOSFET PN8 is connected to the power input port VOLP, the drain of the NMOSFET PN8 is connected to the output port VsP of the output buffer 30, and the voltages at the input ports XP1 and XP2 of the output buffer 30 control the PMOSFET PP8 and the NMOSFET PN8 respectively, thereby generating the output voltage VsP.

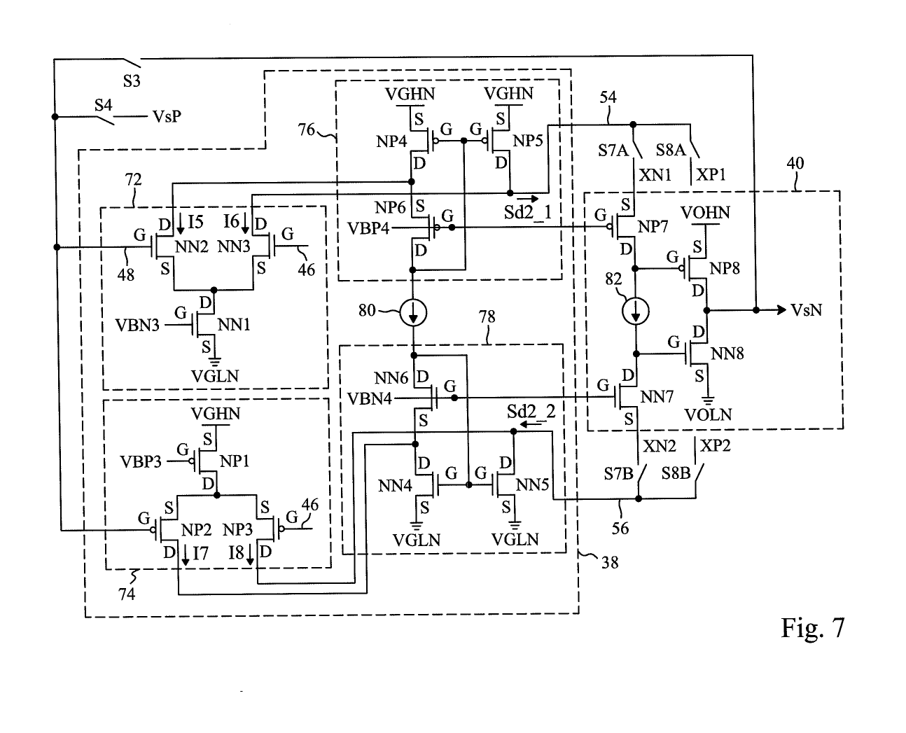

FIG. 7 is a circuit diagram of an embodiment for the gm stage 38 and the output buffer 40 shown in FIG. 5. In the normal operation mode, output ports 54 and 56 of the gm stage 38 are connected to the input ports XN1 and XN2 of the output buffer 40 through switches S7A and S7B, respectively. In the polarity inversion mode, the output ports 54 and 56 of the gm stage 38 are connected to the input ports XP1 and XP2 of the output buffer 30 through switches S8A and S8B, respectively. The gm stage 38 includes input differential pairs 72 and 74, current mirrors 76 and 78, and a bias current source 80 connected between the reference branches of the current mirrors 76 and 78. The input differential pair 72 has NMOSFETs NN1, NN2 and NN3, the source of the NMOSFET NN1 is connected to the power input port VGLN, the gate of the NMOSFET NN1 receives a bias voltage VBN3, the drain of the NMOSFET NN1 is connected to the sources of the NMOSFETs NN2 and NN3, the gate of the NMOSFET NN2 is one of two input ports of the input differential pair 72 and is connected to the input port 48 of the gm stage 38, the drain of the NMOSFET NN2 is one of two output ports of the input differential pair 72 and is connected to the current mirror 76, the gate of the NMOSFET NN3 is the other input port of the input differential pair 72 and is connected to the input port 46 of the gm stage 38, and the drain of the NMOSFET NN3 is the other output port of the input differential pair 72 and is connected to the current mirror 76. The input differential pair 74 has PMOSFETs NP1, NP2 and NP3, the source of the PMOSFET NP1 is connected to the power input port VGHN, the gate of the PMOSFET NP1 receives a bias voltage VBP3, the drain of the PMOSFET NP1 is connected to the sources of the PMOSFETs NP2 and NP3, the gate of the PMOSFET NP2 is one of two input ports of the input differential pair 74 and is connected to the input port 48 of the gm stage 38, the drain of the PMOSFET NP2 is one of two output ports of the input differential pair 74 and is connected to the current mirror 78, the gate of the PMOSFET NP3 is the other input port of the input differential pair 74 and is connected to the input port 46 of the gm stage 38, and the drain of the PMOSFET NP3 is the other output port of the input differential pair 74 and is connected to the current mirror 78. The current mirror 76 includes PMOSFETs NP4, NP5 and NP6, the sources of the PMOSFETs NP4 and NP5 are connected to the power input port VGHN, the gate of the PMOSFET NP4 is connected to the gate of the PMOSFET NP5 and the drain of the PMOSFET NP6, the drain of the PMOSFET NP4 is connected to the drain of the NMOSFET NN2 and the source of the PMOSFET NP6, the drain of the PMOSFET NP5 is connected to the drain of the NMOSFET NN3 and the output port 54 of the gm stage 38, the gate of the PMOSFET NP6 receives a bias voltage VBP4, and the PMOSFETs NP4 and NP5 are the reference branch and the mirror branch of the current mirror 76, respectively. The current mirror 78 has NMOSFETs NN4, NN5 and NN6, the sources of the NMOSFET NN4 and NN5 are connected to the power input port VGLN, the gate of the NMOSFET NN4 is connected to the gate of the NMOSFET NN5 and the drain of the NMOSFET NN6, the drain of the NMOSFET NN4 is connected to the drain of the PMOSFET NP2 and the source of the NMOSFET NN6, the drain of the NMOSFET NN5 is connected to the drain of the PMOSFET NP3 and the output port 56 of the gm stage 28, the gate of the NMOSFET NN6 receives a bias voltage VBN4, and the NMOSFETs NN4 and NN5 are the reference branch and the mirror branch of the current mirror 78, respectively. The input differential pairs 72 and 74 determine currents 15, 16, 17 and 18 according to the differential voltage between the input ports 46 and 48 of the gm stage 38, and thereby determine the signals Sd2_1 and Sd2_2 at the output ports 54 and 56 of the gm stage 38.

In the embodiment of FIG. 7, the output buffer 40 includes PMOSFETs NP7 and NP8, NMOSFETs NN7 and NN8, and a bias current source 82, the source of the PMOSFET NP7 is connected to the input port XN1 of the output buffer 40, the gate of the PMOSFET NP7 receives the bias voltage VBP4, the drain of the PMOSFET NP7 is connected to the bias current source 82 and the gate of the PMOSFET NP8, the source of the NMOSFET NN7 is connected to the input port XN2 of the output buffer 40, the gate of the NMOSFET NN7 receives the bias voltage VBN4, the drain of the NMOSFET NN7 is connected to the bias current source 82 and the gate of the NMOSFET NN8, the source of the PMOSFET NP8 is connected to the power input port VOHN, the drain of the PMOSFET NP8 is connected to the output port VsN of the output buffer 40, the source of the NMOSFET NN8 is connected to the power input port VOLN, the drain of the NMOSFET NN8 is connected to the output port VsN of the output buffer 40, and the voltages at the input ports XN1 and XN2 of the output buffer 40 control the PMOSFET NP8 and the NMOSFET NN8 respectively, thereby generating the output voltage VsN.

While the present invention has been described in conjunction with preferred embodiments thereof, it is evident that many alternatives, modifications and variations will be apparent to those skilled in the art. Accordingly, it is intended to embrace all such alternatives, modifications and variations that fall within the spirit and scope thereof as set forth in the appended claims.

What is claimed is:

1. A source driver for providing a first output voltage in a first voltage range, and a second output voltage in a second voltage range different from the first voltage range, to two data lines of an LCD panel, the source driver comprising:
a first latch operative to receive and store a first digital grayscale signal;
a second latch operative to receive and store a second digital grayscale signal;
a first level shifter operative to be connected to the first latch in a normal operation mode to convert the first digital grayscale signal into a third digital grayscale signal, and to be connected to the second latch in a polarity inversion mode to convert the second digital grayscale signal into a fourth digital grayscale signal;
a second level shifter operative to be connected to the second latch in the normal operation mode to convert the second digital grayscale signal into the fourth digital grayscale signal, and to be connected to the first latch in the polarity inversion mode to convert the first digital grayscale signal into the third digital grayscale signal;
a positive polarity digital-to-analog converter connected to the first level shifter, converting an output of the first level shifter into a positive polarity analog voltage;
a negative polarity digital-to-analog converter connected to the second level shifter, converting an output of the second level shifter into a negative polarity analog voltage;
a first gm stage amplifying a difference between the positive polarity analog voltage and the first output voltage in the normal operation mode, and amplifying a difference between the negative polarity analog voltage and the second output voltage in the polarity inversion mode;
a second gm stage amplifying the difference between the negative polarity analog voltage and the second output voltage in the normal operation mode, and amplifying the difference between the positive polarity analog voltage and the first output voltage in the polarity inversion mode;
a first output buffer connected to the first gm stage in the normal operation mode to generate the first output voltage applied to a first one of the two data lines according to an output of the first gm stage, and connected to the second gm stage in the polarity inversion mode to generate the first output voltage applied to a second one of the two data lines according to an output of the second gm stage; and
a second output buffer connected to the second gm stage in the normal operation mode to generate the second output voltage applied to the second data line according to the output of the second gm stage, and connected to the first gm stage in the polarity inversion mode to generate the second output voltage applied to the first data line according to the output of the first gm stage.

2. The source driver of claim 1, further comprising:
a first switch connected between an input port of the first gm stage and an output port of the first output buffer, being turned on in the normal operation mode;
a second switch connected between the input port of the first gm stage and an output port of the second output buffer, being turned on in the polarity inversion mode;
a third switch connected between an input port of the second gm stage and the output port of the second output buffer, being turned on in the normal operation mode;
a fourth switch connected between the input port of the second gm stage and the output port of the first output buffer, being turned on in the polarity inversion mode;
a fifth switch connected between an output port of the first gm stage and an input port of the first output buffer, being turned on in the normal operation mode;
a sixth switch connected between the output port of the first gm stage and an input port of the second output buffer, being turned on in the polarity inversion mode;
a seventh switch connected between an output port of the second gm stage and the input port of the second output buffer, being turned on in the normal operation mode; and
an eighth switch connected between the output port of the second gm stage and the input port of the first output buffer, being turned on in the polarity inversion mode.

3. The source driver of claim 1, wherein the first gm stage has two power input ports respectively receiving a first voltage and a second voltage which is lower than the first voltage, the second gm stage having two power input ports respectively receiving the first voltage and the second voltage, the first output buffer having two power input ports respectively receiving the first voltage and a third voltage which is lower than the first voltage and higher than or equal to the second voltage, and the second output buffer having two power input ports respectively receiving the second voltage and a fourth voltage which is higher than the second voltage and lower than or equal to the first voltage.

4. The source driver of claim 1, wherein the first gm stage has a first input port receiving the first output voltage in the normal operation mode, and receiving the second output voltage in the polarity inversion mode, a second input port receiving the positive polarity analog voltage in the normal operation mode, and receiving the negative polarity analog voltage in the polarity inversion mode, a first output port connected to a first input port of the first output buffer in the normal operation mode, and connected to a first input port of the second output buffer in the polarity inversion mode, and a second output port connected to a second input port of the first output buffer in the normal operation mode, and connected to a second input port of the second output buffer in the polarity inversion mode, and the second gm stage has a first input port receiving the second output voltage in the normal operation mode, and receiving the first output voltage in the polarity inversion mode, a second input port receiving the negative polarity analog voltage in the normal operation mode, and receiving the positive polarity analog voltage in the polarity inversion mode, a first output port connected to the first input port of the second output buffer in the normal operation mode, and connected to the first input port of the first output buffer in the polarity inversion mode, and a second output port connected to a second output port of the second output buffer in the normal operation mode, and connected to a second output port of the first output buffer in the polarity inversion mode.

5. The source driver of claim 4, wherein the first gm stage comprises:
a first input differential pair having two input ports connected to the first input port and the second input port of the first gm stage, respectively;
a second input differential pair having two input ports connected to the first input port and the second input port of the first gm stage, respectively;
a first current mirror having a reference branch connected to a first output port of the first input differential pair, and a mirror branch connected to a second output port of the first input differential pair as well as the first output port of the first gm stage;
a second current mirror having a reference branch connected to a first output port of the second input differential pair, and a mirror branch connected to a second output port of the second input differential pair as well as the second output port of the first gm stage; and
a bias current source connected between the reference branch of the first current mirror and the reference branch of the second current mirror.

6. The source driver of claim 5, wherein the first output buffer comprises:
a second bias current source connected between the first input port and the second input port of the first output buffer;
a first switch connected between a first power input port of the first output buffer and the output port of the first output buffer, and controlled by a voltage on the first input port of the first output buffer; and
a second switch connected between a second power input port of the first output buffer and the output port of the first output buffer, and controlled by a voltage on the second input port of the first output buffer.

7. The source driver of claim 4, wherein the second gm stage comprises:
a first input differential pair having two input ports connected to the first input port and the second input port of the second gm stage, respectively;
a second input differential pair having two input port connected to the first input port and the second input port of the second gm stage, respectively;
a first current mirror having a reference branch connected to a first output port of the first input differential pair, and a mirror branch connected to a second output port of the first input differential pair and the first output port of the second gm stage;
a second current mirror having a reference branch connected to a first output port of the second input differential pair, and a mirror branch connected to a second output port of the second input differential pair as well as the second output port of the second gm stage; and
a bias current source connected between the reference branch of the first current mirror and the reference branch of the second current mirror.

8. The source driver of claim 7, wherein the second output buffer comprises:
a second bias current source connected between the first input port and the second input port of the second output buffer;
a first switch connected between a first power input port of the second output buffer and the output port of the second output buffer, and controlled by a voltage on the first input port of the second output buffer; and
a second switch being connected between the second power input port of the second output buffer and the output port of the second output buffer, controlled by a voltage on the second input port of the second output buffer.
